(19) United States
(12) Patent Application Publication
(10) Pub. No.: US 2017/0067454 A1
(43) Pub. Date: Mar. 9, 2017

(54) COMPRESSED AIR ENERGY STORAGE SYSTEM

(71) Applicant: ISOCURRENT ENERGY INCORPORATED, Toronto (CA)

(72) Inventor: Dimitre KARAMANEV, London, Ontario (CA)

(21) Appl. No.: 15/119,201

(22) PCT Filed: Feb. 23, 2015
(86) PCT No.: PCT/CA2015/050137

§ 371 Date: Aug. 16, 2016

Related U.S. Application Data
(60) Provisional application No. 61/943,408, filed on Feb. 23, 2014.
(60) Provisional application No. 62/007,602, filed on Jun. 4, 2014.

(51) Int. Cl. F04B 9/02; H02J 15/00; F04B 17/02; F04B 23/02; F03D 9/17; F03C 1/30

(52) U.S. Cl. CPC F04B 9/02; F03D 9/17; F03C 1/0409; F04B 17/02; F04B 23/02; H02J 15/006

(57) ABSTRACT

A hydraulic energy flow conversion device is for use in association with a compressed air storage unit and an input device. The input device is for inputting mechanical energy. The hydraulic energy flow conversion device includes a first hydraulic cylinder and a means for decreasing the displacement rate during the compression cycle. The first hydraulic cylinder includes a first hydraulic piston and has a compression cycle, an expansion cycle and a displacement rate. The first hydraulic cylinder is operably connected to the compressed air storage unit. The first hydraulic piston is operably connected to the input device. The energy input device may be a wind turbine.

### FIELD OF THE DISCLOSURE

This disclosure relates to energy storage systems and in particular energy storage systems that use compressed air.

### BACKGROUND

The storage and smoothing of the electrical energy produced from variable renewable sources such as wind and solar, is a very important problem. The compressed air energy storage (CAES) is one of the most promising ways to store energy. Recently an isothermal, or more precisely, pseudo-isothermal compressed air energy storage (ItCAES) technology was proposed (PCT/CA2013/050972). Some key features include therein are the very close to isothermal compression and expansion of a gas (air), high efficiency, simplicity and the low cost.

The main drawback of the system described in PCT/CA2013/050972 was the need for several liquid pumps/motors because of the highly varying pressure in the compression/expansion unit.

### SUMMARY

A hydraulic energy flow conversion device is for use in association with a compressed air storage unit and an input device. The input device is for inputting mechanical energy. The hydraulic energy flow conversion device includes a first hydraulic cylinder and a means for decreasing the displacement rate during the compression cycle. The first hydraulic cylinder includes a first hydraulic piston and has a compression cycle, an expansion cycle and a displacement rate. The first hydraulic cylinder is operably connected to the compressed air storage unit. The first hydraulic piston is operably connected to the input device. The energy input device may be a wind turbine.

The input device may provide generally constant power during the compression cycle. The means for decreasing the displacement rate may be a crank mechanism operably connected between the input device and the first hydraulic piston.

The hydraulic energy flow conversion device may include at least a second hydraulic cylinder having a second hydraulic piston, the second hydraulic cylinder being operably connected to the compressed air storage unit and the second hydraulic piston being operably connected to crank mechanism such that the compression cycles of the first hydraulic cylinder and the second hydraulic cylinder are shifted in phase relative to each other.

The means for decreasing the displacement rate may be a cam mechanism operably connected between the input device and the first hydraulic piston.

The hydraulic energy flow conversion device may include at least a second hydraulic cylinder having a second hydraulic piston, the second hydraulic cylinder being operably connected to the compressed air storage unit and the second hydraulic piston being operably connected to cam mechanism such that the compression cycles of the first hydraulic cylinder and the second hydraulic cylinder are shifted in phase relative to each other.

The first hydraulic cylinder may be a rotational hydraulic cylinder and further including a fixed hydraulic cylinder having a piston and the first hydraulic piston may be operably hingably attached to the piston of the fixed hydraulic cylinder and the fixed hydraulic cylinder may be connected between the input device and the first hydraulic cylinder and the fixed hydraulic cylinder may be the means for decreasing the displacement rate of the first hydraulic cylinder whereby an angle between the first hydraulic cylinder and the fixed hydraulic cylinder varies as the first hydraulic cylinder moves through the compression cycle.

The hydraulic energy flow conversion device may include a second hydraulic cylinder having a second hydraulic piston, and a link having opposed ends, and the first hydraulic piston being operably hingeably attached to the link at one ed thereof and the second hydraulic piston may be operably hingeably attached to the link at the opposed end thereof and the first hydraulic cylinder and second hydraulic cylinder in a fixed relationship relative to each other, the second hydraulic cylinder being operably attached between the input device and the first hydraulic cylinder and being the means for decreasing the displacement rate.

The hingeably attached link may be a half scissor jack. The first hydraulic cylinder may be generally perpendicular to the second hydraulic cylinder. The first hydraulic cylinder and second hydraulic cylinder form a first two cylinder jack mechanism and may include a second two cylinder jack mechanism shifted in time by 180 degrees.

The hydraulic energy flow conversion device may include a third hydraulic cylinder having a third hydraulic piston the third hydraulic piston being operably hingeably attached to f the first hydraulic piston with a second link and wherein the third hydraulic cylinder may be operably attached to the input device and wherein the second and third cylinders are aligned and generally perpendicular to the first hydraulic cylinder.

The first link and the second together may be a two third scissor jack.

The hydraulic energy flow conversion device may include a third hydraulic cylinder having a third hydraulic piston the third hydraulic piston being operably hingeably attached to the second hydraulic piston with a second link and wherein the third hydraulic cylinder may be operably attached to compressed air storage unit and wherein the first cylinder and third cylinder are aligned and generally perpendicular to the second hydraulic cylinder.

The hydraulic energy flow conversion device may include a second hydraulic cylinder having a second hydraulic piston, a third hydraulic cylinder having a third hydraulic piston, a fourth hydraulic cylinder having a fourth hydraulic piston, the first hydraulic piston, second hydraulic piston, third hydraulic piston and fourth hydraulic are operably hingeably connected with a four links, the first hydraulic cylinder and second hydraulic cylinder being operably connected to the compressed air storage unit, the third hydraulic cylinder and the fourth hydraulic cylinder being operably connected to the input device and wherein the third and fourth cylinders are the means for decreasing the rate of displacement.

The first hydraulic cylinder and the second hydraulic cylinder are aligned, the third hydraulic cylinder and the fourth hydraulic cylinder may be aligned and generally perpendicular to the aligned first hydraulic cylinder and second hydraulic cylinder, the four links may be a scissor jack.

The first hydraulic cylinder, second hydraulic cylinder, third hydraulic cylinder and fourth hydraulic cylinder form a four cylinder assembly and may include a second four cylinder assembly operably connected to the second four cylinder assembly.

The input device may be operably connected to a wind turbine.

The wind turbine may include a crank shaft operably connected to at least one crank hydraulic cylinder and the crank hydraulic cylinder being operably connected to a compression/expansion vessel which may be operably connected to the third hydraulic cylinder and the fourth hydraulic cylinder. The hydraulic energy flow conversion device may include a plurality of crank hydraulic cylinders.

The hydraulic energy flow conversion device may include a hydraulic motor operably connected to the crank hydraulic cylinders wherein the crank hydraulic cylinders are selectively connected to the first hydraulic cylinder and second hydraulic cylinder and the hydraulic motor.

The wind turbine may include a crank shaft operably connected to the first hydraulic piston.

The hydraulic energy flow conversion device may include a hydraulic motor operably connected to the crank hydraulic cylinders wherein the crank hydraulic cylinders are selectively connected to the first hydraulic piston and the hydraulic motor.

The input device may be an electric motor and may include a hydraulic pump operably connected between the electric motor and the third hydraulic cylinder and the fourth hydraulic cylinder.

The hydraulic energy flow conversion device may include an accumulator unit operably connected between the hydraulic pump and the third hydraulic cylinder and the fourth hydraulic cylinder.

The hydraulic energy flow conversion device may include a liquid container operably connected to the hydraulic pump and selectively connected to the third hydraulic cylinder and the fourth hydraulic cylinder.

The hydraulic energy flow conversion device may include a second hydraulic cylinder having a second hydraulic piston, a first linear motor and a second linear motor the first hydraulic piston, second hydraulic piston, first linear motor and second linear motor are operably hingeably connected with a four links, the first hydraulic cylinder and second hydraulic cylinder being operably connected to the compressed air storage unit, the first and second motors being the input device and the hingeable links attached to the first and second motors are the means for decreasing the rate of displacement.

The hydraulic energy flow conversion device may include a second hydraulic cylinder having a second hydraulic piston, a first rotary motor connected to a rack-and-pinion and a second rotary motor connected to a rack-and-pinion the first hydraulic piston, second hydraulic piston, pinion of the first rotary motor and the pinion of the second rotary motor are operably hingeably connected with four links, the first hydraulic cylinder and second hydraulic cylinder being operably connected to the compressed air storage unit, the first and second rotary motors being the input device and the hingeable links attached to the first and second rotary motors are the means for decreasing the rate of displacement. The four hingeable links may be a scissor jack.

An apparatus for pseudo-isothermal energy conversion for use with a wind turbine having a crank shaft including a compression/expansion vessel; a compressed air storage vessel operably connected to the compression vessel; at least one crank hydraulic cylinder having a crank piston, crank piston being attached to the crank shaft and the crank hydraulic cylinder being operably connected to the compression/expansion vessel; a hydraulic motor; and a hydraulic energy conversion device having an input end being operably connected to the compression/expansion vessel and an output end being operably connected to the hydraulic motor.

The apparatus may include a plurality of crank hydraulic cylinders and crank pistons each crank piston being attached to the crank shaft and each crank cylinder being operably attached to the compression/expansion vessel.

The hydraulic motor may be selectively connected to the crank hydraulic cylinders.

The apparatus may include a hydraulic accumulator operably connected between the output end of the hydraulic energy conversion device and the hydraulic motor.

The hydraulic accumulator may be operably connected between the crank hydraulic cylinder and the hydraulic motor.

The hydraulic energy conversion device includes a first hydraulic cylinder having a first hydraulic piston, a second hydraulic cylinder having a second hydraulic piston, a third hydraulic cylinder having a third hydraulic piston, a fourth hydraulic cylinder having a fourth hydraulic piston, the first hydraulic piston, second hydraulic piston, third hydraulic piston and fourth hydraulic are connected with a jack mechanism, the first hydraulic cylinder and second hydraulic cylinder being the input, the third hydraulic cylinder and the fourth hydraulic cylinder being the output.

The jack mechanism may be a scissor jack.

Further features will be described or will become apparent in the course of the following detailed description.

### BRIEF DESCRIPTION OF THE DRAWINGS

The embodiments will now be described by way of example only, with reference to the accompanying drawings, in which:

FIG. 1 is a schematic diagram of an isothermal compressed air storage system;

FIG. 2 is a schematic drawing of the ItCAES with a hydraulic cylinder;

FIG. 3 is graphical representation of the pressure change during a compression cycle;

FIG. 4 is a graphical representation of the change in the piston force during a compression cycle;

FIG. 5 is a graphical representation of the change in the displacement rate during the compression cycle;

FIG. 6 is a graphical representation of the pressure change during the expansion cycle;

FIG. 7 is a graphical representation of the change of the piston displacement rate during the expansion cycle;

FIG. 8 is a graphical representation of the profile of the linear displacement of a crank mechanism;

FIG. 9 is a schematic diagram of a crank mechanism relating to the profile of FIG. 8;

FIG. 10 is a graphical representation of the force distribution along the crank angle of the crank mechanism of FIG. 9 and showing a comparison of the pressure force during gas compression;

FIG. 11 is a schematic diagram of a two cylinder crank mechanism;

FIG. 12 is a schematic diagram of a cam type crank mechanism;

FIG. 13 is a schematic diagram of a two cylinder cam type mechanism;

FIG. 14 is a schematic diagram of a compressed air storage system for use with a set of hydraulic cylinders;

FIG. 15 is a schematic diagram of a four cylinder and scissor jack assembly;

FIG. 15A is a schematic diagram similar to that shown in FIG. 15 but with two cylinders and two linear motors;

FIG. 15B is a schematic diagram similar to that shown in FIGS. 15 and 15A but with two cylinders and two rotational motors with rack-and-pinion;

FIG. 15C is a schematic diagram similar to FIG. 15 but showing two four cylinder and scissor jack assembly;

FIG. 16 is a schematic diagram of a jack crank mechanism similar to that shown in FIG. 15 but using three cylinders and three jacks;

FIG. 17 is a schematic diagram similar to that shown in 15 and using a two cylinder two jack mechanism similar to the crank mechanism shown in FIG. 15;

FIG. 18 is a schematic diagram of a compressed air storage system using the two cylinder two jack crank mechanism of FIG. 17 wherein the cycles are off set;

FIG. 19 is a schematic diagram of a two cylinder crank mechanism wherein the cylinders are connected at variable angles;

FIG. 20 is a flow chart showing the revisable compression-expansion of the compressed air storage system;

FIG. 21 is a flow chart showing a compressed air storage and energy production system that may be used with a photovoltaic system;

FIG. 22 is a schematic diagram of a prior art electro-mechanical system of a wind turbine;

FIG. 23 is a flow chart for the energy conversion for use in a wind turbine system;

FIG. 24 is a schematic diagram of a combined wind turbine and isothermal compressed air storage system;

FIG. 25 is a schematic diagram of an alternate embodiment of a combined wind turbine and isothermal compressed air storage system.

### DETAILED DESCRIPTION

For gas compression, the ItCAES can use either high speed (between 200 and 5000 rpm) hydraulic pumps, or a low speed (between 1 and 300 cycles per minute) hydraulic cylinders. Similar or the same hydraulic cylinders and hydraulic pumps/motors having similar speeds as the compression units can be used for the process of gas expansion. In general, the low speed hydraulic cylinders require linear motion as mechanical input, while the high speed pumps require rotational mechanical motion as an energy input. Similarly, the low speed hydraulic cylinders produce linear mechanical energy, while the high speed hydraulic motors produce rotational mechanical energy as an output during the air expansion.

The ItCAES receives mechanical energy as an energy input and produces mechanical energy as an energy output. The main components of the ItCAES are the converters of mechanical to hydraulic energy during the compression (energy storage) cycle, and the conversion of hydraulic to mechanical energy during the expansion (energy release) cycle. The general energy conversion structure of the ItCAES is shown below:

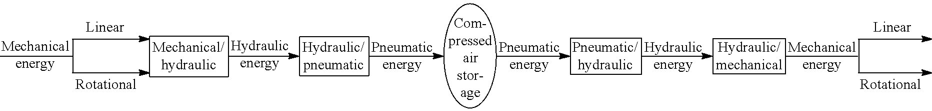

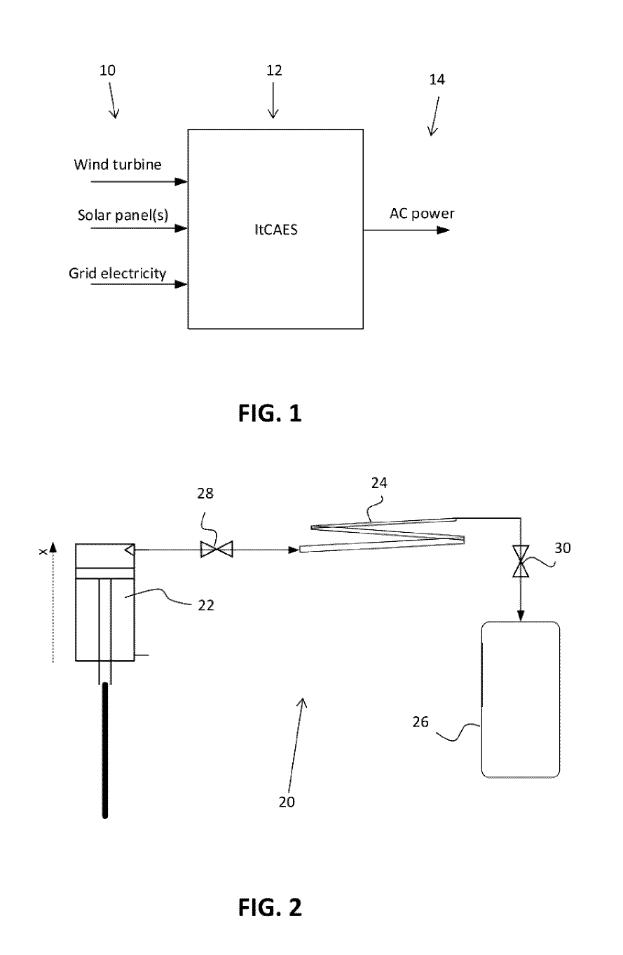

The basics of the ItCAES (isothermal compressed air energy storage) was disclosed in (PCT/CA2013/050972). Various mechanical energy inputs 10 to ItCAES 12 and outputs 14 from ItCAES can fit different energy source and energy output forms as shown in FIG. 1. By way of example only energy inputs 10 may be wind turbine, solar panels and/or grid electricity. Each of the mechanical inputs and output of the ItCAES can be in the two forms: (1) linear motion, represented by hydraulic cylinder(s); (2) rotational motion, represented by hydraulic motor(s) and/or pump(s). Normally, the linear motion has a lower frequency, in the range between 1 and 100 cycles per minute. The rotational speed of hydraulic pumps and motors is normally in the range between 200 and 5000 cycles per minute (rpm).

The technologies that provide mechanical energy to the ItCAES and that receive mechanical energy from the ItCAES may be either rotational at higher or lower speed range or linear at lower frequencies.

When the compression unit in the ItCAES obtains hydraulic energy from a hydraulic cylinder, the general compression scheme is shown in FIG. 2. A schematic representation of ItCAES is shown generally at 20 in FIG. 2. The ItCAES may include a hydraulic cylinder 22, operably connected to a compression vessel 24 which is operably connected to a compressed air storage vessel 26. A valve 28 is connected between the hydraulic cylinder 22 and the compression vessel 24 and valve 30 is connected between the compression vessel 24 and compressed air storage vessel 26. It should be noted that the hydraulic cylinder 22 shown in FIG. 2 can be powered by a mechanical device, known in the engineering practice, such as linear actuator or a linear motor. The change in gas pressure in the compression vessel 24 of the ItCAES during the compression cycle is given by the following formula:

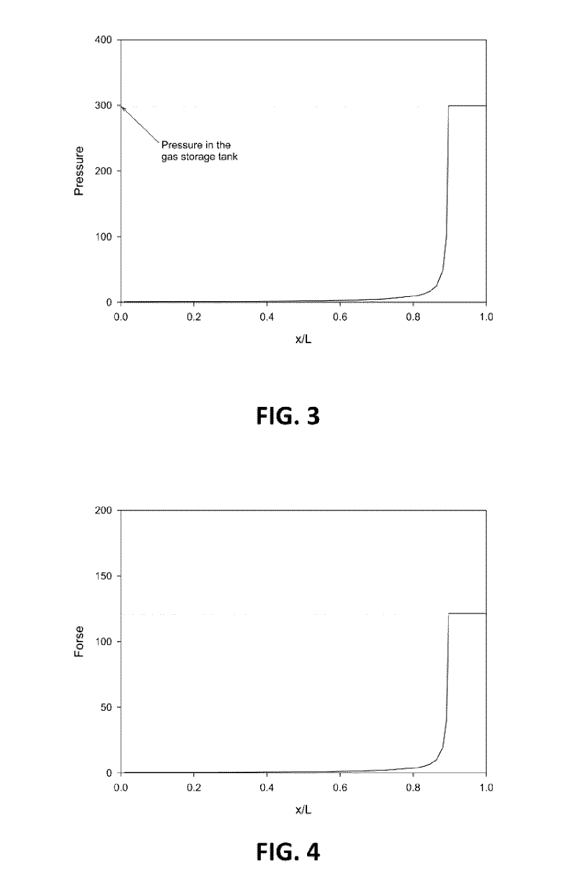

P=Pₒ*U(L−x) (1)

Where P is the pressure when the displacement of the hydraulic cylinder equal to x; Pₒ is the initial pressure at x=0 (at the beginning of compression) and L is the total cylinder displacement during the compression cycle. The graphical representation of pressure change during the compression cycle is shown in FIG. 3.

The force on the hydraulic piston (F) is proportional to the pressure in the cylinder (which is almost equal to the pressure in the compression unit) and to the cross-sectional area of the piston (A):

F=P*A (2)

The change in the piston force during the compression cycle is shown in FIG. 4.

The relationship between the cylinder displacement rate (V=x/time) and the power consumption for gas compression is given by:

Power=P*V (3)

It is preferable to apply a generally constant mechanical power (Power) during the compression cycle. Therefore, the displacement rate should change during the compression cycle according to the following equation, combining Eqs. 1 and 3:

V=Power/P=Power*(L−x)/(Pₒ*L) (4)

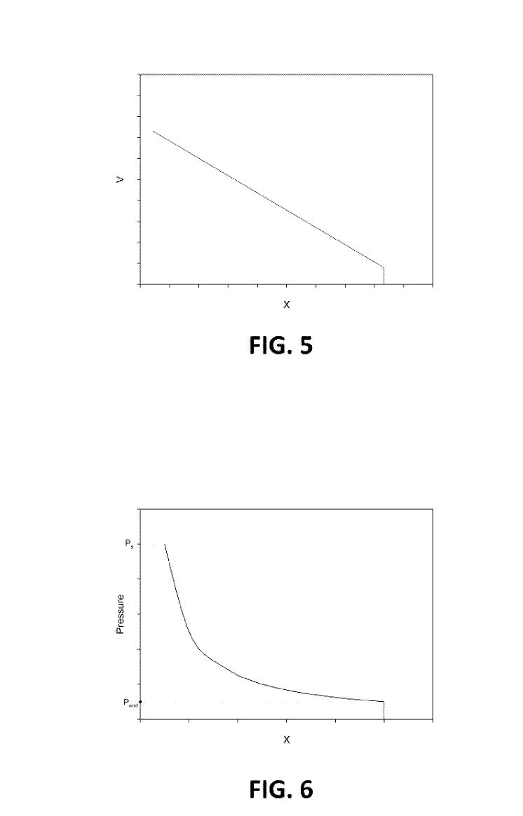

Graphically the change of the displacement rate needed to obtain constant power during the compression cycle is shown in FIG. 5.

During the compression cycle, the pressure in the compression unit is increased until it reaches approximately the pressure in the compressed air storage vessel (FIG. 3). After that point, the air is transported from the compression unit to the compressed air storage vessel.

FIGS. 3 and 4 and equations 1, 3 and 4 show that the pressure in the compression unit (which is almost equal to the pressure in the compressing hydraulic cylinder) increases during the compression cycle approximately by a factor of Pₛ/Pₒ (where Pₛ is the final compression pressure, almost equal to that in the compressed air storage vessel). At the same time, the cylinder displacement rate (which is proportional to the hydraulic liquid flow rate) decreases during the compression cycle by a factor of Pₛ/Pₒ. Therefore, it is advantageous to invent a drive unit for the hydraulic compressing cylinder, which would allow to maintain approximately constant power of compression during the compression cycle, while having variable pressure and displacement rate (V). That means that it is advantageous that the displacement rate of the cylinder during the compression cycle follows approximately or exactly Eq. 4 and FIG. 5.

The process of expansion in the expansion unit is a reverse of the process of compression. During the expansion, the pressure in the expansion vessel (which is almost equal to the pressure in the hydraulic cylinder) decreases from the pressure in the compressed air storage vessel (Pₛ) to the final pressure P_{end}, which is usually close to the atmospheric pressure. (The final pressure is typically between the atmospheric pressure and approximately ten times the atmospheric pressure). The hydraulic cylinder used in the process of expansion is shown in FIG. 2. Therefore, the pressure in the expansion unit will change as:

P=Pₛ*xₛ/(xₛ+x) (5)

Where xₛ is the position of the hydraulic piston at the beginning of expansion cycle (when the compression vessel is filled with air from the compressed air storage vessel) and x is the displacement at any point of the expansion process. x varies between zero and (L−xₛ). L is the total displacement of the hydraulic cylinder during the process of expansion. It should be noted that the final pressure of the process of expansion is equal to the pressure when x=L. The pressure change during the expansion cycle is shown graphically in FIG. 6. The pressure decreases by a factor of Pₛ/P_{end}.

Since the force on the hydraulic piston is proportional to the pressure in the hydraulic cylinder (Eq. 2), the force on the piston will also decrease by a factor of Pₛ/P_{end}.

The mechanical power obtained during the cycle of expansion is related to the hydraulic cylinder displacement rate according to Equation 3. In order to maintain close to constant power during the expansion cycle, the hydraulic piston displacement rate should be:

V=Power/P=Power*(xₛ+x)/(Pₛ*xₛ) (6)

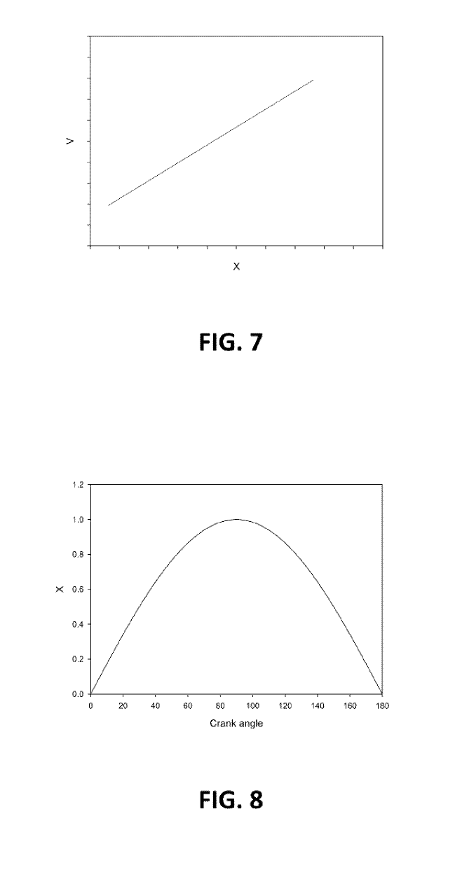

Graphically the change of the piston displacement rate during the expansion cycle is shown in FIG. 7.

Therefore, in order to obtain exactly or approximately constant power during the expansion cycle, it is advantageous to invent a piston driven system, which will accept a variable piston displacement rate similar to that predicted by Eq. 6 and by FIG. 7, and a variable piston force during the expansion cycle.

The typical time of the cycle of either gas compression or gas expansion in the ItCAES, described above, is between 0.5 seconds and 30 seconds.

There are different systems that can drive the above-described piston for the process of gas compression and the energy producing system driven by the hydraulic piston in the case of gas expansion. The list below shows examples of the possible primary drive systems for air compression and energy production systems for air expansion in the ItCAES:

1. Forms of energy inputs for air compression (power storage):
1.1. Mechanical rotation at low speeds (0.5 to 300 rpm). Typical example: wind turbine
1.2. Mechanical rotation at high speeds (200 to 5000 rpm). Typical examples: electrical motors driven by AC or DC power:
   1.2.1. The AC motor may be driven by power supplied from the grid, by existing wind turbine(s) or by existing solar panel(s) with inverter(s)
   1.2.2. The DC motor may be driven by solar panel(s)
1.3. Linear motion
   1.3.1. Linear AC or DC motor
   1.3.2. AC or DC motor running a rack-and-pinion transmission.
      2. Energy produced by air expansion (power generation):
2.1. AC power. Examples:
   2.1.1. For grid connection
   2.1.2. For powering local customer(s)
2.2. DC power. Examples:
   2.2.1. For charging batteries (such as in the case of battery-operated automobiles)
   2.2.2. For conversion to AC power.

The following systems satisfy the requirement for the above-listed primary energy inputs (1) and for the energy production (2) in the ItCAES.

### 1. Types of Energy Inputs to the ItCAES

1.1. Mechanical Rotation at Low Speeds (Approx. 0.5 to 300 Rpm)

The primary energy input to the ItCAES can be rotational mechanical energy at low speeds. Typical examples are powering the ItCAES directly by the rotating shaft of a wind turbine or a low-speed electrical motor. The conversion of the rotational motion (of the rotating shaft) to linear motion (the hydraulic cylinder) can be done by well known methods such as cam mechanism (disk or cylindrical) or a crank mechanism. While the displacement rate of the cylinder driven by a cam can have a highly variable profiles during the rotational cycle, depending on the profile of the cam, the force and linear displacement rate profile of the crank mechanism is well determined.

1.1.1. Crank Mechanism

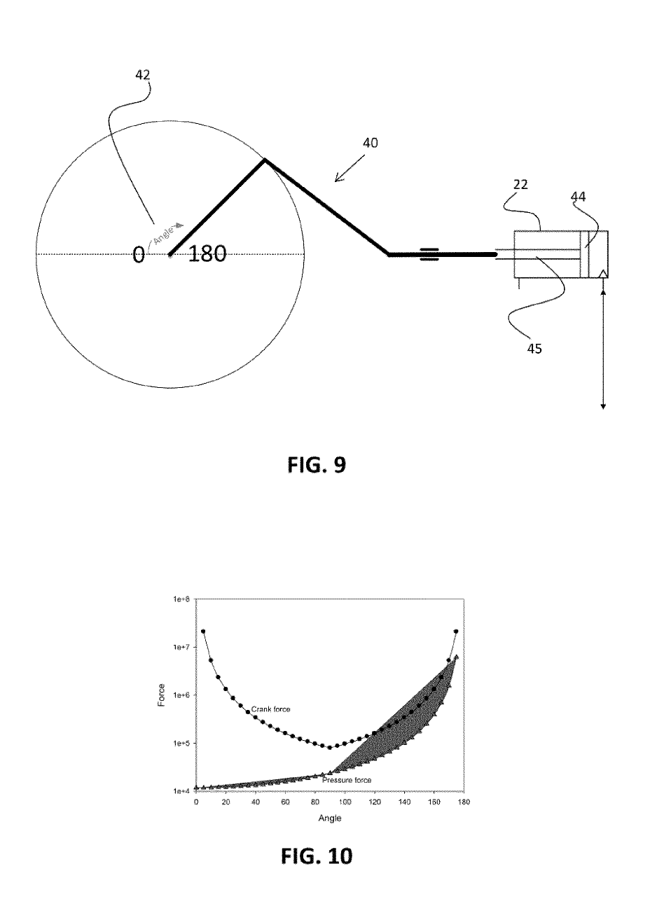

The profile of linear displacement of a crank mechanism 40 is shown in FIG. 8. A typical crank moving a cylinder is shown in FIG. 9. The crank mechanism would be attached to an input device for providing power to the piston 44 of the hydraulic cylinder 22. Note that the piston 44 is attached to a piston rod 45 however for ease of description hereafter piston is used for the combination of piston and piston rod. The hydraulic cylinder 22 is operably connected to the compression vessel 24 as described above.

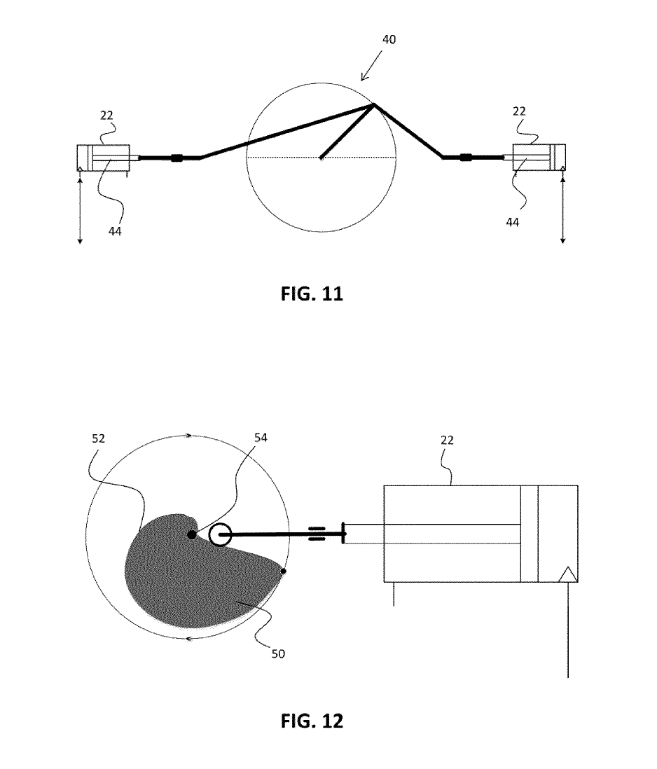

It can be seen that the force distribution along the crank angle 42, and therefore, piston axis 44 (FIG. 10) between 90 and 180 degree (see FIG. 9) fits very well the pressure force variation during gas compression (FIG. 10). While the crank-cylinder mechanism 40 will work with one cylinder 22, it is advantageous to have more than one, for example two (FIG. 11), or even more advantageous, four cylinders, spaced around the crank at equal angles (180 degree for the case of two cylinders or 90 degree for the case of four cylinders). In general there may be any number of hydraulic cylinders attached to a crank mechanism. The cylinders are connected to the crank mechanism 40 such that their compression cycles are shifted in phase relative to each other.

1.1.2. Cam Mechanism (FIG. 12).

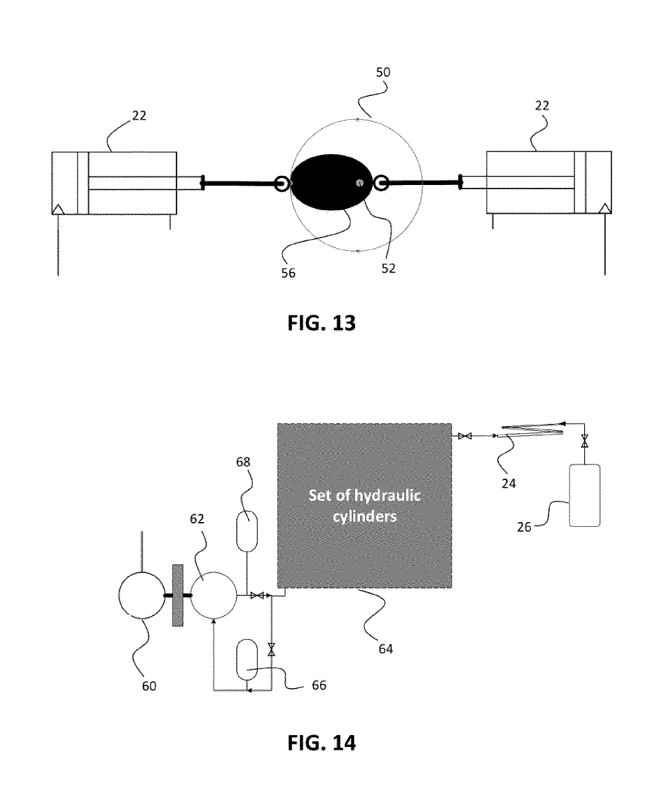

There are different types of cam mechanisms, such as disk and cylindrical barrel, which can be used to drive a cylinder. The force and the linear displacement profile of a cam mechanism depends on the profile of the cam. An exemplary profile of a disk cam mechanism 50 includes a cam 52 which has a center of rotation 54 and which would follow approximately the displacement profile of the gas compression force in a cylinder 22 (FIG. 4). One cam can power one or more hydraulic cylinders. FIG. 13 shows the case of two cylinders 22 with a generally oval shaped cam 56 and wherein the cylinders 22 are shifted in phase relative to each other

1.2. Mechanical Rotation at High Speed

High speed mechanical rotation is usually provided by an electrical, either DC or AC, motor. Alternatively, it can be provided by other devices such as a combustion engine or by a heat engine. Since the hydraulic cylinders driving the gas compression unit require low frequency (between 1 and 300 cycles per minute) linear reciprocal motion, it is advantageous to convert the high-speed (200-4000 rpm) mechanical rotational motion into a low-frequency linear motion. Two of the possible ways for such a conversion are shown below.

1.2.1. Reducing Gear with Crank or Cam Mechanism

The high speed rotating shaft can be connected to a reducing gear mechanism in order to decrease the rotational speed to low frequency (1-300 rpm). Further, the low frequency rotational motion can be converted to a linear motion using a cam or a crank mechanism, as described in 1.1.1 and in 1.1.2.

1.2.2. Hydraulic Speed Reduction

The conversion from high speed rotation (for example, 200-5000 rpm) to linear motion with variable force but constant power during the compression cycle (as shown in FIG. 4) can be also achieved using hydraulic components. The high speed rotation, usually provided by a DC or AC electrical motor 60, powers a hydraulic pump 62, preferably having nearly constant flow rate, pressure and power in time (FIG. 14). The high-pressure hydraulic liquid produced by the hydraulic pump 62, enters a set of hydraulic cylinders 64. The set of hydraulic cylinders 64 is connected to the compression vessel 24 and the compressed air storage vessel 26 described above. The set of hydraulic cylinders will be described in details below.

1.2.2.1. Four-Cylinder Converter (Full Jack)

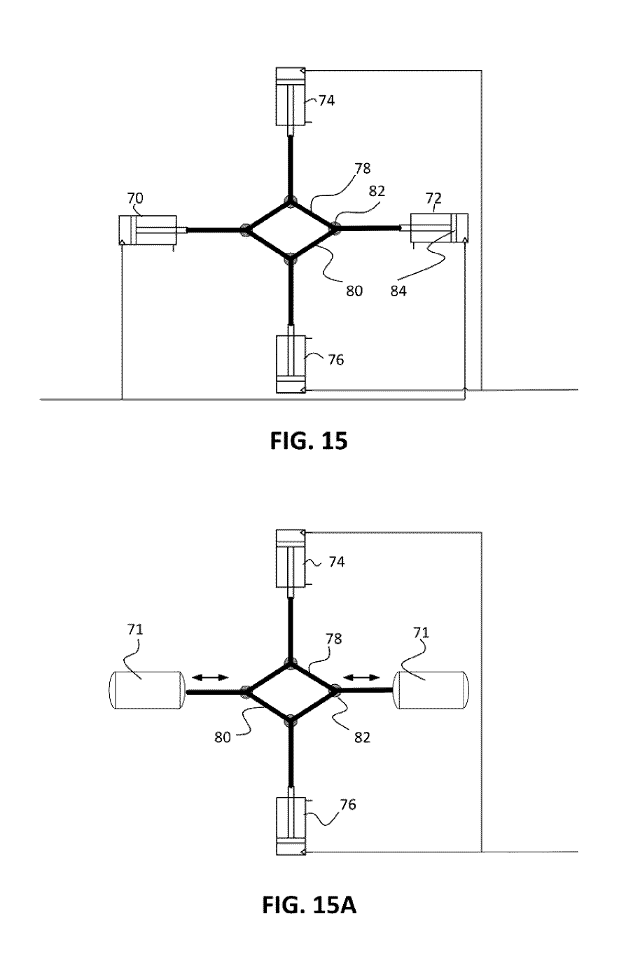

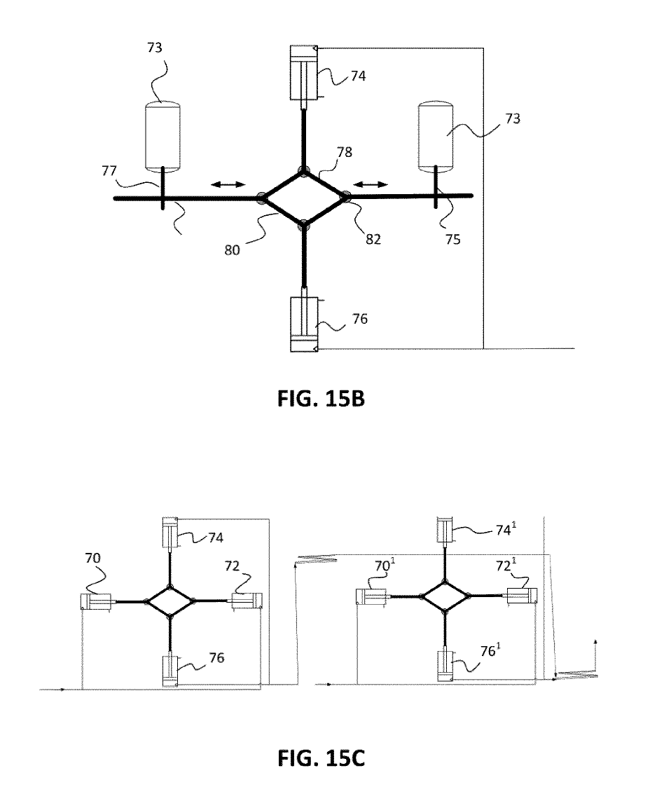

The set of hydraulic cylinder 64 shown in FIG. 14 can be represented by a four-cylinders jack mechanism, where the number of hydraulic cylinders powered by the hydraulic pump, is two (cylinders 70 and 72 in FIG. 15). These two cylinders are connected to another pair of hydraulic cylinders (74 and 76) via a jack mechanism 78. The jack mechanism 78 is a scissor jack and includes four links 78 pivotally attached together at a hinge 82. The hinge 82 is attached to the piston 84 of the respective cylinders 70, 72, 74, 76. The cylinders are in a fixed relationship to each other and the jack mechanism 78 is moveable relative to the cylinders. Preferably the cylinders are arranged such that cylinders 70 and 72 are axially aligned and cylinders 74 and 76 are axially aligned and generally perpendicular to cylinders 70 and 72. The mathematical model of the jack mechanist shown in FIG. 15 shows that when a constant pressure and constant displacement (constant liquid flow rate) are applied simultaneously to the pair of cylinders 70 and 72, both the force and displacement profile in time of the pair of cylinders 74 and 76 follow closely the profiles of gas compression force shown in FIG. 4.

When one 4-cylinder jack mechanism is used in FIG. 14, the operation contains the following cycles: (1) filling the cylinders 70 and 72 with hydraulic liquid by the hydraulic pump 62 (shown in FIG. 14) and compression of the gas in the gas compression unit 24 by cylinders 74 and 76, (2) emptying the cylinders 74 and 76 to the liquid container 66 which is under or close to atmospheric pressure and filling the accumulator unit 68 by the hydraulic pump 62. The accumulator unit 68 is under the pressure of or close to the output pressure of the hydraulic pump 62. Then the cycle repeats according to (1) and (2).

1.2.2.2. Three-Cylinder Converter (¾-Jack)

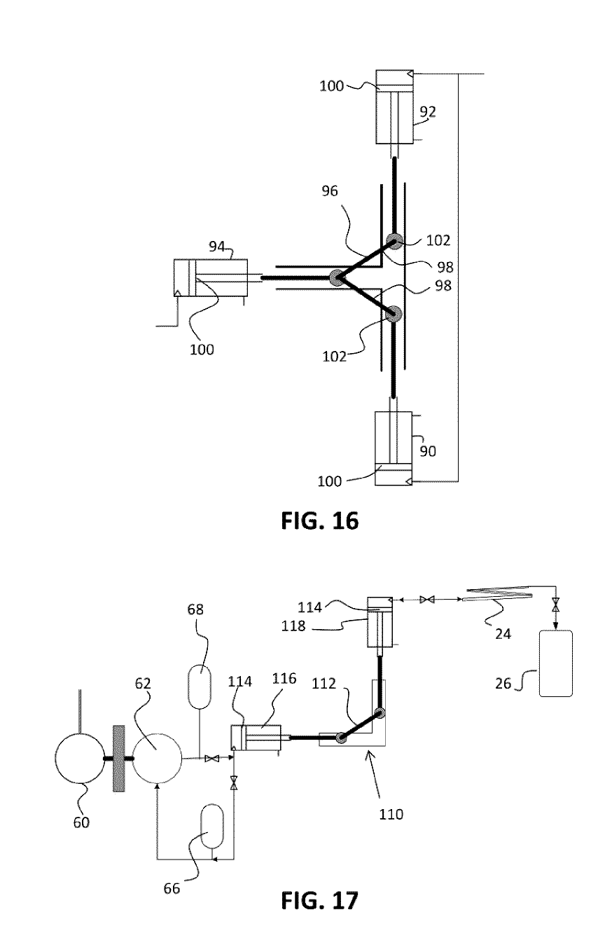

One nearly constant-pressure and flow rate liquid pump 62, described above, can feed two compression hydraulic cylinders 90, 92, connected via a jack mechanism 96 preferably a ¾ scissor jack 2 to an emptying cylinder 94 as shown in FIG. 16. The fluid parameters, including the time-distribution, are similar to those obtained by the full-jack mechanism (1.2.2.1). Alternatively, the liquid pump can feed the cylinder 94 and the resulting variable pressure and flow rate can be obtained by the two cylinders 90 and 92 (FIG. 16). As described above the cylinders are in a fixed relationship to each other and it is the jack mechanism that moves. The jack mechanism 96 is a ¾ scissors jack includes two links 98 pivotally attached to each other and pivotally attached to the pistons of the respective cylinders 100 at hinges 102. The pistons 100 move inwardly and outwardly in the respective cylinders in a fixed relationship. Preferably cylinders 90 and 92 are axially aligned and cylinder 94 is generally perpendicular thereto.

1.2.2.3. Two-Cylinders Converter (Half Jack)

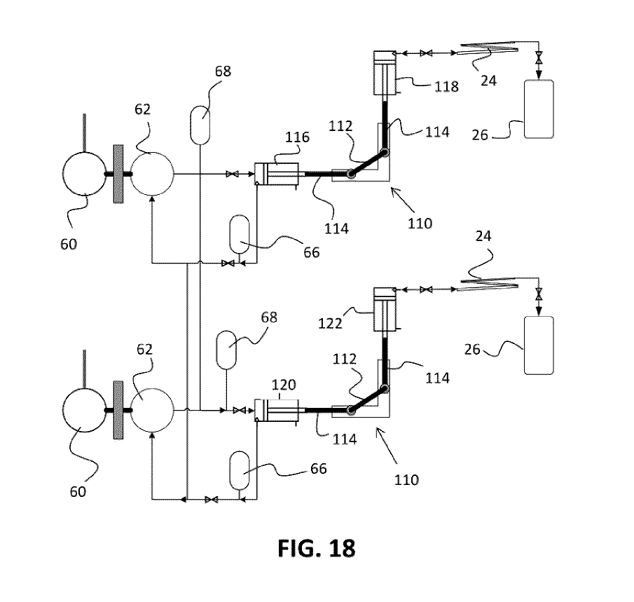

The effect achieved by the mechanism described in 1.2.2.1 (FIG. 15) can be also achieved by a using a jack mechanism 100 preferably a half scissor jack (FIG. 17) as the set of hydraulic cylinders 64 shown in FIG. 14. Similar pressure and flow rate time-profile of the half-jack mechanism are obtained as in the full-jack (1.2.2.1). The half-scissors jack mechanism 110 includes one link 112 pivotally attached to the pistons 114 of the respective cylinders 116 at hinges 117. The link 112 is operably hingeably attached at opposed ends to the pistons 114. The pistons 114 move inwardly and outwardly in the respective cylinders in a fixed relationship. Preferably cylinders 116 and 118 are generally perpendicular to each other. When two 2-cylinder jack mechanisms are used in tandem (FIG. 18), these two mechanisms are shifted in time by 180 degree, i.e. when the cylinder 116 is filled, the cylinder 120 is emptied, and vice-versa. In that case the hydraulic pump 62 (FIG. 14) operates with much less variation in time. The system shown in FIG. 14 can contain more than two parallel systems, but shifted in time mechanisms. Each of the elements of these mechanisms can contain a full, half or ⅔ jack converters.

1.2.2.4. Hydraulic Cylinders Connected at Variable Angle

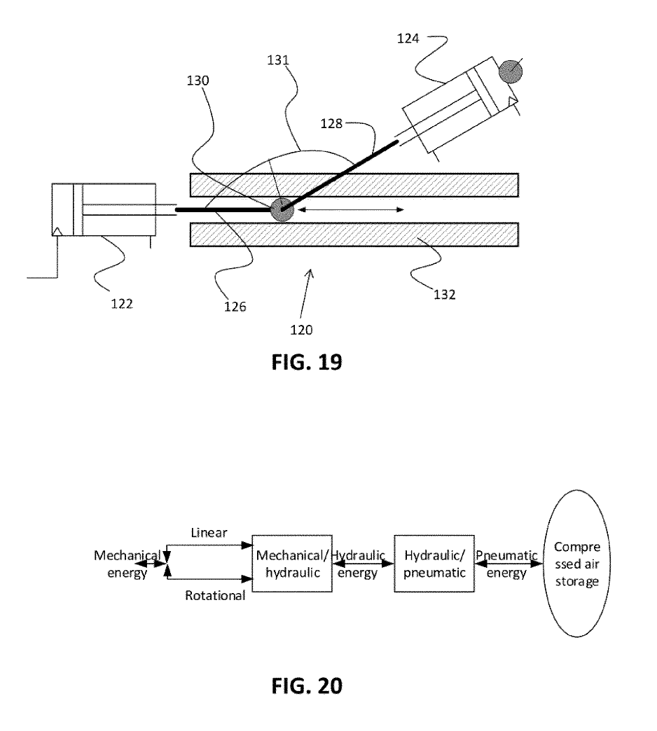

The set of hydraulic cylinders 64 shown in FIG. 14 can be also represented by two or more hydraulic cylinders connected so that the angle between their axes varies. The system is shown in FIG. 19 at 120. System 120 includes a fixed cylinder 122 and a rotating cylinder 124. Piston 126 of the fixed cylinder 122 is pivotally attached to piston 128 of the rotational cylinder 124 at hinge point 130. The motion of piston 126 of the fixed cylinder 122 is constrained such that is moves axially inwardly and outwardly in cylinder 122. In contrast the orientation of piston 128 of rotating cylinder 124 changes as the piston 126 of the fixed cylinder 122 moves inwardly and outwardly. Thus the angle 131 between the fixed cylinder 122 and the rotational cylinder 124 varies as the cylinders move through their cycles. A bearing may be used at the hinge point 130. The bearing may be constrained in a channel 132.

The mechanical motion of the hydraulic cylinders described in the jack mechanisms (1.2.2.1, 1.2.2.2.1.2.2.3, 1.2.2.4) describes only the working (forward) motion of the cylinders. The reverse motion (reaching back the initial point by retraction) of the hydraulic cylinders can be achieved by well known methods such as using a spring or using double action cylinders, where the reverse motion can be achieved by pumping liquid to the back of the piston (to the chamber containing the rod).

1.3. Mechanical Energy Input in the Form of Linear Motion

1.3.1. Linear AC or DC Electrical Motor

Linear motors 71 can replace the cylinders 70 and 72 in FIG. 15, as shown in FIG. 15A. In that case there is no need for a liquid pump/motor (62 in FIG. 14) and for cylinders 70 and 72 in FIG. 15.

1.3.2. AC or DC Motor Running a Rack-and-Pinion Transmission

The linear motion driving the cylinders that fill the compression unit can be provided by an rotational electrical motor 73 connected to a rack (75)-and-pinion (77) device (FIG. 15B). The two rotational motors on FIG. 15B can be replaced by a single linear motor, driving both arms of the jack mechanism in opposite directions, using a double rack (two racks, connected to the opposite sides of the pinion and driving two opposite hinges). Especially advantageous may be the roller pinion due to its very low friction.

When the compression ratio P/Pₒ is large, for example larger than 10, it may be advantageous to use two or more stages of each of the compression and expansion systems described in section 1 above. In that case the compression from Po to P will be carried out in two or more stages.

Alternatively, a two-stage compression and expansion can be achieved in a full jack mechanism, similar to that shown in FIG. 15. In that case, there are two cycles: in cycle 1, cylinders 70 and 72 are connected to a liquid pump during their forward motion and drive cylinders 74 and 76. In cycle 2, during the backwards motion, cylinders 70 and 72 are connected to a compression unit and act as a second-stage compression cylinders. During the cycle 2 cylinders 70 and 72 are driven by either cylinders 74 and 76 (which at this cycle are connected to a liquid pump) or by a set of two cylinders, connected in parallel, but oppositely to cylinders 74 and 76.

### 2. Energy Produced by Air Expansion in ItCAES (Power Generation):

Following the storage of the primary energy input in the form of compressed air (point 1 above), the ItCAES produces mechanical energy by expanding the compressed gas. The produced energy can be either in the form of low-frequency (for example 1-300 cycles per minute) reciprocal motion, or as high-speed rotational motion (for example 200-5000 rpm). In most cases it is desirable to produce electrical energy as the final energy form after storage. Electrical energy is usually produced using electrical generators (for AC power) or dynamo machines (for DC power). Since both electrical generators and dynamo machines usually use high speed mechanical rotation as an energy input, it is desirable to produce high speed mechanical energy by the ItCAES, which can further be converted to either AC or DC power. Listed below are examples of the methods for the generation of rotational high-speed mechanical energy.

2.1. Fully Reversible Compression-Expansion.

The fully reversible compression-expansion can be applied when the form of the energy input to the system is the same as the form of the energy output, for example AC input-AC output, or DC input-DC output. All the methods listed under the point 1.1 (1.1.1 and 1.1.2) and 1.2 above (1.2.1, 1.2.2.1, 1.2.2.2, 1.2.2.3) can be used reversibly to both compress and expand gases, and therefore, to store and produce electrical energy (FIG. 20). In that case the hydraulic pump needs to operate as a pump/motor and the electrical motor needs to operate as a motor/generator (dynamo). During the energy generation, it is advantageous to introduce to the expansion unit compressed gas from the compressed gas storage vessel with certain volume, as described in PCT/CA2013/050972.

In order to introduce a certain volume of compressed gas to the expansion unit, it is advantageous to remove from the unit the same amount of liquid. This can be done by either moving the piston in the hydraulic cylinder to remove liquid, or by using an auxiliary cylinder for the control of the volume of removed liquid.

2.2. ItCAES with Different Forms of Input and Output Energy

2.2.1. DC Input-AC Output

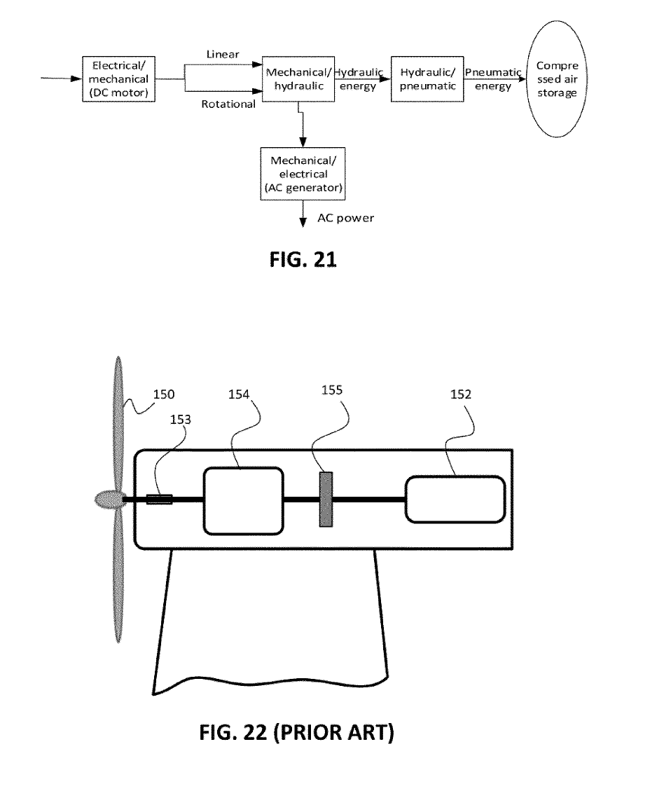

This variation of the ItCAES is particularly useful in the case of the storage of electrical energy generated from photovoltaic systems. The exemplary schematics view of the system is shown in FIG. 21. The energy is stored to the ItCAES by using a DC motor, while the ItCAES produces AC electricity by the AC generator.

2.2.2. Low Speed Mechanical Input—AC Output

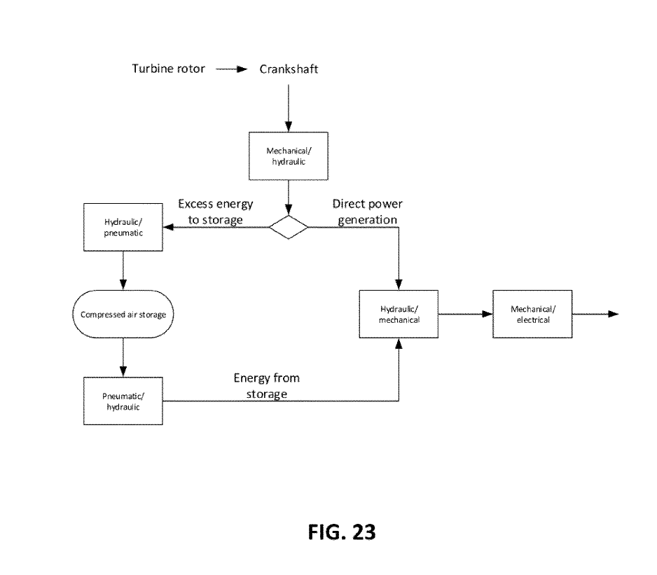

This system is of interest for the storage of wind-produced energy. A general representation of the prior art electro-mechanical systems in a wind turbine is shown in FIG. 22. It is well known that the rotational speeds of most wind turbine rotors 150 vary between 5 and 100 rpm. At the same time, the rotational speeds of the electrical generators 152 used in wind turbine systems are usually between 700 and 3600 rpm. In order to transform the low speed of the rotor to the high speed of the electric generator, a high ratio gear box 154 is normally used (FIG. 22). In addition the wind turbine includes bearings 153 where needed. As well, a wind turbine may include a disk brake 155 between the gear box 154 and the electrical generator 152. In most cases, the cost of the gear box 154 represents between 10% and 30% of the cost of the entire wind turbine system.

From the above summary it can be seen that the rotational speed of the wind rotor fits well the speed of the hydraulic cylinder-based compression sub-unit of the ItCAES, while the rotational speed of the wind-based electrical generator fits well the hydraulic motor-based expander of the ItCAES. The energy conversion map in the complete wind turbine—ItCAES system is shown schematically in FIG. 23. The rotational energy of the wind rotor is converted to a reciprocal one using a crankshaft mechanism. The crankshaft drives hydraulic cylinder(s) which convert its mechanical energy to the hydraulic energy of pressurized liquid. The pressurized liquid then can be divided into two streams—one directed towards a hydraulic to mechanical energy converter (hydraulic motor) for immediate electrical power generation, and the other directed towards the compressed air energy storage system. The energy storage system consists of a hydraulic to pneumatic converter (a compression vessel) and a compressed air storage tank. When the stored compressed air energy needs to be converted to electricity, the compressed air energy is converted to hydraulic energy in a pneumatic/hydraulic converter (expanding vessel), which is further connected to the hydraulic motor (hydraulic/mechanical converter). The mechanical energy from the latter is converted to electricity using an electrical generator (mechanical/electrical converter).

During the wind turbine operation, there are four possible temporal scenarios:
1. The amount of wind energy is the same as the amount of electrical energy needed. In that case all the wind energy should be converted to electrical energy right away. All the hydraulic liquid is transferred from the cylinders to the hydraulic motor.
2. If the amount of energy provided by the wind is more than the electrical energy needed to be produced at any point of time, the surplus wind energy will be stored in the form of compressed air by sending the hydraulic liquid from the cylinders to the air compression unit, and from there—to the compressed air storage vessel. Therefore, part of the hydraulic liquid exiting the hydraulic cylinders will be directed towards the hydraulic motor, while another part will be directed towards the air compression unit(s).
3. If the amount of energy provided by wind is less than the required electrical energy output, then all of the hydraulic liquid exiting the hydraulic cylinders will be directed towards the hydraulic motor. At the same time, the compressed air will provide additional energy to produce additional electricity. To achieve that, compressed air will enter the expansion unit(s), which will produce high pressure hydraulic liquid. The latter is directed towards the hydraulic motor.
4. If there is wind energy available, but there is no need to produce any electrical power, then all the hydraulic liquid exiting the hydraulic cylinders will be directed towards the air compression vessels and all the wind energy will be stored in the form of compressed air. No hydraulic fluid will enter the hydraulic motor.

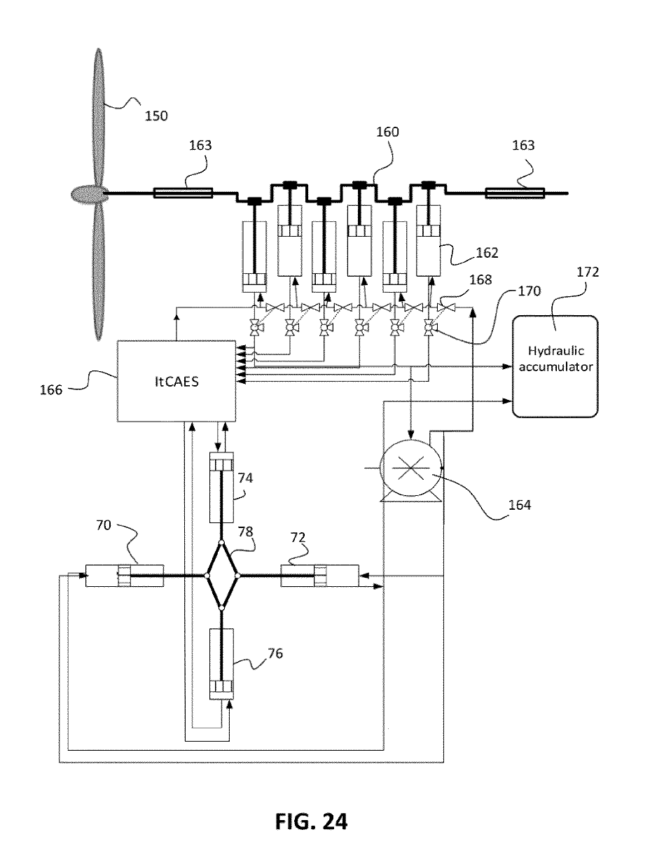

FIG. 24 shows the basic idea of the wind turbine/ItCAES system. The wind, spinning the turbine rotor 150, produces a rotational mechanical motion with a speed usually between 5 and 100 rpm. Using a crankshaft 160, the rotational motion is converted to reciprocal one, driving one or more hydraulic cylinders 162. Bearings 163 are used where needed. The high pressure liquid exiting these cylinders 162 is connected both to a hydraulic motor 164 (running electrical generator) and/or to an ItCAES 166, where the energy of pressurized liquid is used to compress air and store it. A set of two-way valves 168, connected in pairs with 3-way valves 170 (the connections are shown with dotted lines), direct the liquid flow from the hydraulic cylinders 162 to either the hydraulic motor 164 via hydraulic accumulator 172, to the ItCAES 166, or to both. When a valve 168 is closed, the corresponding valve 170 is opened towards the tCAES 166 and at the same time, closed towards the hydraulic motor 164. When a valve 168 is opened, the corresponding valve 170 is closed towards the ItCAES 166 and opened towards the hydraulic motor 164. When part of the valves 168 are opened and part of them closed (scenario 2 above), the opened ones should be at the right-hand side, and the closed ones should be at the left-hand side. The ratio between the amount of pressurized liquid flowing to the hydraulic motor 164 and to the ItCAES 166 depends on the ratio between the amount of energy to be generated right away and energy to be stored for later generation. That ratio may vary between 0 (all the wind energy is stored—scenario 4 above) and 1 (the wind energy is converted to electricity right away—scenario 1 above). The liquid flowing out of the hydraulic motor 164 and flowing from the ItCAES 166 flows back to the hydraulic cylinders 162, where it is used in another cycle of pressurizing. It should be noted that the way of distribution of the pressurized liquid between the hydraulic motor 164 and the ItCAES 166, described in FIG. 24, is just exemplary, and can be achieved by many other means known in the engineering practice, for example by linking each of the hydraulic cylinders with the hydraulic motor using individual parallel pipes. The individual cylinders can be shifted at 180° by the crankshaft, or at any other angle.

Preferably the fluid connection between the hydraulic cylinders 162 and the hydraulic motor 164 is a liquid one. Therefore, the variation of the fluid force due to the periodic operation of the cylinders 162 can be smoothed by well-known methods in hydraulics means, such as by using a hydraulic accumulator 172. In the case of scenario 3 and 4 above, part or all of the energy driving the hydraulic motor 14, and therefore, the electrical generator, comes from the ItCAES 166. The energy of compressed air is converted to the energy of pressurized liquid in ItCAES 166. Then the pressurized liquid drives the hydraulic cylinders 74 and 76 (FIG. 24) as described above. The variable force produced by the cylinders 74 and 76 during each cycle is smoothed by using a scissor jack mechanism 78 connected to a pair of hydraulic cylinders 70 and 72. The latter produce hydraulic liquid with close to constant pressure. The cylinders 70 and 72 are connected to the hydraulic motor 164 via hydraulic accumulator 172, which rotates the electrical generator and produces electricity.

Alternatively, the full-jack mechanism containing the cylinders 70, 72, 74, 76 and the full scissor jack mechanism 78 (FIG. 24), can be replaced by any of the converters described in sections 1.2.2.2.-1.2.2.4 above.

The conversions of the:
mechanical wind energy to pressurized hydraulic energy (crankshaft 160 and cylinder 162);
hydraulic to compressed air energy (compression/expansion unit 180);
compressed air to hydraulic energy (compression/expansion unit 180);
hydraulic to mechanical (cylinders 70, 72, 74, 76 with scissor jack 78 and hydraulic motor 164);
mechanical to electric energy (electrical generator)
   are shown next.

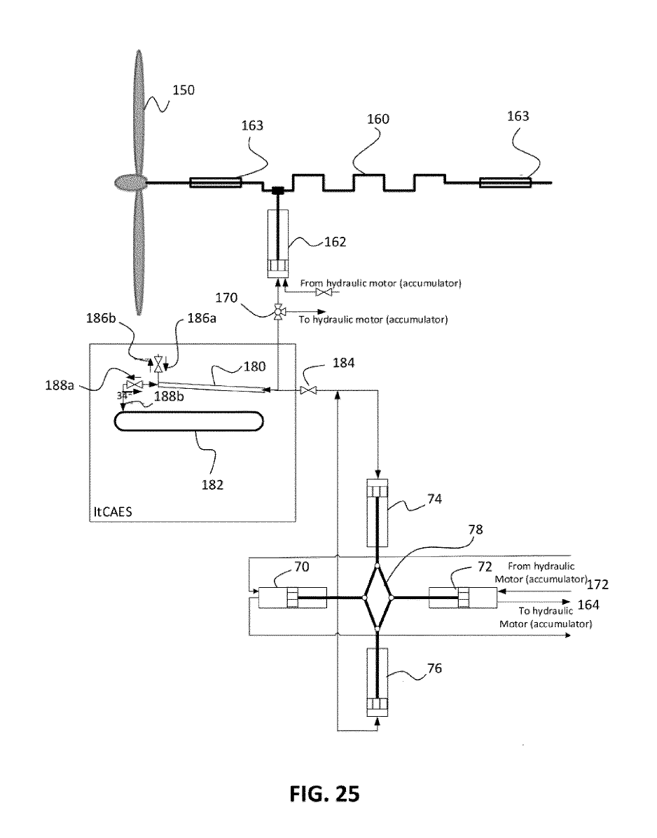

The conversion of mechanical wind energy to pressurized hydraulic energy and further to compressed air is carried out by using the combination of a crankshaft and a hydraulic cylinder as shown in FIG. 25. The pressure of the compressing air in the compression/expansion unit 180 creates a force against the piston in cylinder 162 equal to: F=P*A, where P is the pressure of air in the compression unit 130 and A is the frontal area of the piston. The pressure in the compression unit raises in each cycle from close to atmospheric one to the pressure in the compressed air storage tank 182. Therefore the force on the piston may change drastically during each compression cycle, especially at higher pressure in the compressed air storage tank 182. The change in the linear force on a piston, driven by a crankshaft during the rotation cycle, is well described in the literature. Comparing the pressure force and the opposing it crankshaft force on the hydraulic cylinder 162, it can be shown that the profiles of the driving force of the crankshaft and the opposing it pressure force are very similar during each cycle of crankshaft rotation. Therefore, the compression of air in the compressing unit 180 should be done in one cycle of the piston movement, and the volume of liquid in the cylinder 162 should be close to and preferably smaller than the volume of liquid in the compression vessel 180. The operation of the energy storage system in the compression mode is as follows: Valve 184 is closed and three way valve 170 is open between the cylinder 162 and the compression unit 180 of the ItCAES 166. Check valve 186 works only towards the compression unit 180. The check valve 188a opens only towards the compressed air storage vessel 182. At that time the valve 186b is closed, the check valve 188a is opened and 188b is closed. This way, the rotational motion of the wind turbine is converted to a reciprocal motion using the crankshaft 160, the linear motion drives the cylinder 162, which produces high-pressure liquid. The latter compresses atmospheric air in the compression/expansion unit 180 and stores it in the compressed air tank 182. The description of the ItCAES unit, given here, is simplified. The complete description of the ItCAES is given in the PCT Application PCT/CA2013/050972. Also, the description of the compression and the expansion cycles in FIGS. 3 and 6 shows only one chain of hydraulic cylinder 162—compression/expansion unit 180—gas storage tank 182—compression/expansion unit 180—hydraulic cylinder(s) 74 (and 76)—scissor jack 78—hydraulic cylinder(s) 70 (and 72). It should be underlined that there may be many parallel chains with the same or different volumes of the cylinders and the compression/expansion units, as shown schematically in FIG. 24. The conversion of the stored high-pressure air to hydraulic and then to mechanical energy is also shown in FIG. 25. In that mode, the valve 170 is closed between the compression/expansion unit 180 and the cylinder 162. Initially, valve 184 is closed or partially opened to allow a small amount of liquid to leave the compression unit, allowing compressed air (having the same volume as the escaped liquid) to enter the expansion unit. Valve 188b is opened periodically only to allow a pre-determined quantity of compressed air to the compression/expansion unit 180. Then, valve 184 in opened. The pressurized by the compressed gas liquid flows into the hydraulic cylinders 74 and 76. The scissor jack 78 together with the hydraulic cylinders 70 and 72 are used to smooth the variable liquid pressure in cylinders 74 and 76. By way of example only, it can be shown that the pressure of the liquid leaving cylinders 70 and 72 varies only slightly, when the pressure in the cylinders 74 and 76 drops from 300 bar to 1 bar during the cycle of air expansion in the compression/expansion unit 180. The pressure of the liquid leaving cylinders 70 and 72 depends mostly on their diameters, the diameters of the cylinders 74 and 76, the pressure of the compressed air in the tank 182 and the starting and final opening (final angle) of the scissor jack. When the pressure in the tank 182 drops down during the process of extraction of energy from the compressed gas, the initial vertical (as shown in FIG. 25) opening of the scissor jack 78 needs to be decreased in order to maintain a close to constant output pressure in cylinders 70 and 72. The operation of the ItCAES is described in details in the PCT application PCT/CA2013/050972.

In the above text it was mentioned that the initial pressure of air entering the ItCAES is close to atmospheric. However, it is also possible to introduce to the ItCAES air with higher than atmospheric pressure, compressed by a compressor or other means.

Generally speaking, the systems described herein are directed to compressed air energy storage systems. Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “operably connected to” means that the two elements are connected either directly or indirectly.

As used herein, the term “exemplary” means “serving as an example, instance, or illustration,” and should not be construed as preferred or advantageous over other configurations disclosed herein.

Unless defined otherwise, all technical and scientific terms used herein are intended to have the same meaning as commonly understood to one of ordinary skill in the art.

1. A hydraulic energy flow conversion device for use in association with a compressed air storage unit and an input device for inputting mechanical energy, the hydraulic energy flow conversion device comprising:
a first hydraulic cylinder including a first hydraulic piston and having a compression cycle, an expansion cycle and a displacement rate, the first hydraulic cylinder being operably connected to the compressed air storage unit and the first hydraulic piston being operably connected to the input device; and
a means for decreasing the displacement rate during the compression cycle.

2. The hydraulic energy flow conversion device of claim 1 wherein the input device provides generally constant power during the compression cycle.

3. The hydraulic energy flow conversion device of claim 1 wherein the means for decreasing the displacement rate is a crank mechanism operably connected between the input device and the first hydraulic piston.

4. The hydraulic energy flow conversion device of claim 3 further including at least a second hydraulic cylinder having a second hydraulic piston, the second hydraulic cylinder being operably connected to the compressed air storage unit and the second hydraulic piston being operably connected to crank mechanism such that the compression cycles of the first hydraulic cylinder and the second hydraulic cylinder are shifted in phase relative to each other.

5. The hydraulic energy flow conversion device of claim 1 wherein the means for decreasing the displacement rate is a cam mechanism operably connected between the input device and the first hydraulic piston.

6. The hydraulic energy flow conversion device of claim 5 further including at least a second hydraulic cylinder having a second hydraulic piston, the second hydraulic cylinder being operably connected to the compressed air storage unit and the second hydraulic piston being operably connected to cam mechanism such that the compression cycles of the first hydraulic cylinder and the second hydraulic cylinder are shifted in phase relative to each other.

7. The hydraulic energy flow conversion device of claim 1 wherein the first hydraulic cylinder is a rotational hydraulic cylinder and further including a fixed hydraulic cylinder having a piston and the first hydraulic piston is operably hingably attached to the piston of the fixed hydraulic cylinder and the fixed hydraulic cylinder is connected between the input device and the first hydraulic cylinder and the fixed hydraulic cylinder is the means for decreasing the displacement rate of the first hydraulic cylinder whereby an angle between the first hydraulic cylinder and the fixed hydraulic cylinder varies as the first hydraulic cylinder moves through the compression cycle.

8. The hydraulic energy flow conversion device of claim 1 further including a second hydraulic cylinder having a second hydraulic piston, and a link having opposed ends, and the first hydraulic piston being operably hingeably attached to the link at one end thereof and the second hydraulic piston is operably hingeably attached to the link at the opposed end thereof and the first hydraulic cylinder and second hydraulic cylinder in a fixed relationship relative to each other, the second hydraulic cylinder being operably attached between the input device and the first hydraulic cylinder and being the means for decreasing the displacement rate.

9. The hydraulic energy flow conversion device of claim 8 wherein the hingeably attached link is a half scissor jack.

10. The hydraulic energy flow conversion device of claim 8 wherein the first hydraulic cylinder is generally perpendicular to the second hydraulic cylinder.

11. The hydraulic energy flow conversion device of claim 8 wherein the first hydraulic cylinder and second hydraulic cylinder form a first two cylinder jack mechanism and further including a second two cylinder jack mechanism shifted in time by 180 degrees.

12. The hydraulic energy flow conversion device of claim 8 further including a third hydraulic cylinder having a third hydraulic piston the third hydraulic piston being operably hingeably attached to f the first hydraulic piston with a second link and wherein the third hydraulic cylinder is operably attached to the input device and wherein the second and third cylinders are aligned and generally perpendicular to the first hydraulic cylinder.

13. The hydraulic energy flow conversion device of claim 11 wherein the first link and the second together are a two third scissor jack.

14. The hydraulic energy flow conversion device of claim 8 further including a third hydraulic cylinder having a third hydraulic piston the third hydraulic piston being operably hingeably attached to the second hydraulic piston with a second link and wherein the third hydraulic cylinder is operably attached to compressed air storage unit and wherein the first cylinder and third cylinder are aligned and generally perpendicular to the second hydraulic cylinder.

15. The hydraulic energy flow conversion device of claim 1 further including a second hydraulic cylinder having a second hydraulic piston, a third hydraulic cylinder having a third hydraulic piston, a fourth hydraulic cylinder having a fourth hydraulic piston, the first hydraulic piston, second hydraulic piston, third hydraulic piston and fourth hydraulic are operably hingeably connected with a four links, the first hydraulic cylinder and second hydraulic cylinder being operably connected to the compressed air storage unit, the third hydraulic cylinder and the fourth hydraulic cylinder being operably connected to the input device and wherein the third and fourth cylinders are the means for decreasing the rate of displacement.

16. The hydraulic energy flow conversion device of claim 15 wherein the first hydraulic cylinder and the second hydraulic cylinder are aligned, the third hydraulic cylinder and the fourth hydraulic cylinder are aligned and generally perpendicular to the aligned first hydraulic cylinder and second hydraulic cylinder, the four links are a scissor jack.

17. The hydraulic energy flow conversion device of claim 15 wherein the first hydraulic cylinder, second hydraulic cylinder, third hydraulic cylinder and fourth hydraulic cylinder form a four cylinder assembly and further including a second four cylinder assembly operably connected to the second four cylinder assembly.

18. The hydraulic energy flow conversion device of claim 16 wherein the input device is operably connected to a wind turbine.

19. The hydraulic energy flow conversion device of claim 18 wherein the wind turbine includes a crank shaft operably connected to at least one crank hydraulic cylinder and the crank hydraulic cylinder being operably connected to a compression/expansion vessel which is operably connected to the third hydraulic cylinder and the fourth hydraulic cylinder.

20. The hydraulic energy flow conversion device of claim 19 further including a plurality of crank hydraulic cylinders.

21. The hydraulic energy flow conversion device of claim 19 further including a hydraulic motor operably connected to the crank hydraulic cylinders wherein the crank hydraulic cylinders are selectively connected to the first hydraulic cylinder and second hydraulic cylinder and the hydraulic motor.

22. The hydraulic energy flow conversion device of claim 1 wherein the input device is operably connected to a wind turbine.

23. The hydraulic energy flow conversion device of claim 22 wherein the wind turbine includes a crank shaft operably connected to the first hydraulic piston.

24. The hydraulic energy flow conversion device of claim 23 further including a plurality of crank hydraulic cylinders.

25. The hydraulic energy flow conversion device of claim 24 further including a hydraulic motor operably connected to the crank hydraulic cylinders wherein the crank hydraulic cylinders are selectively connected to the first hydraulic piston and the hydraulic motor.

26. The hydraulic energy flow conversion device of claim 18 wherein the input device is an electric motor and further including a hydraulic pump operably connected between the electric motor and the third hydraulic cylinder and the fourth hydraulic cylinder.

27. The hydraulic energy flow conversion device of claim 26 further including an accumulator unit operably connected between the hydraulic pump and the third hydraulic cylinder and the fourth hydraulic cylinder.

28. The hydraulic energy flow conversion device of claim 27 further including a liquid container operably connected to the hydraulic pump and selectively connected to the third hydraulic cylinder and the fourth hydraulic cylinder.

29. The hydraulic energy flow conversion device of claim 1 further including a second hydraulic cylinder having a second hydraulic piston, a first linear motor and a second linear motor the first hydraulic piston, second hydraulic piston, first linear motor and second linear motor are operably hingeably connected with a four links, the first hydraulic cylinder and second hydraulic cylinder being operably connected to the compressed air storage unit, the first and second motors being the input device and the hingeable links attached to the first and second motors are the means for decreasing the rate of displacement.

30. The hydraulic energy flow conversion device of claim 1 further including a second hydraulic cylinder having a second hydraulic piston, a first rotary motor connected to a rack-and-pinion and a second rotary motor connected to a rack-and-pinion the first hydraulic piston, second hydraulic piston, pinion of the first rotary motor and the pinion of the second rotary motor are operably hingeably connected with four links, the first hydraulic cylinder and second hydraulic cylinder being operably connected to the compressed air storage unit, the first and second rotary motors being the input device and the hingeable links attached to the first and second rotary motors are the means for decreasing the rate of displacement.

31. The hydraulic energy flow conversion device of claim 29 wherein the four hingeable links are a scissor jack.

32. An apparatus for pseudo-isothermal energy conversion for use with a wind turbine having a crank shaft comprising:
a compression/expansion vessel;
a compressed air storage vessel operably connected to the compression vessel;
at least one crank hydraulic cylinder having a crank piston, crank piston being attached to the crank shaft and the crank hydraulic cylinder being operably connected to the compression/expansion vessel;
a hydraulic motor;
a hydraulic energy conversion device having an input end being operably connected to the compression/expansion vessel and an output end being operably connected to the hydraulic motor.

33. The apparatus of claim 32 further including a plurality of crank hydraulic cylinders and crank pistons each crank piston being attached to the crank shaft and each crank cylinder being operably attached to the compression/expansion vessel.

34. The apparatus of claim 33 wherein the hydraulic motor is selectively connected to the crank hydraulic cylinders.

35. The apparatus of claim 34 further including a hydraulic accumulator operably connected between the output end of the hydraulic energy conversion device and the hydraulic motor.

36. The apparatus of claim 35 wherein the hydraulic accumulator is operably connected between the crank hydraulic cylinder and the hydraulic motor.

37. The apparatus of claim 34 wherein the hydraulic energy conversion device includes a first hydraulic cylinder having a first hydraulic piston, a second hydraulic cylinder having a second hydraulic piston, a third hydraulic cylinder having a third hydraulic piston, a fourth hydraulic cylinder having a fourth hydraulic piston, the first hydraulic piston, second hydraulic piston, third hydraulic piston and fourth hydraulic are connected with a jack mechanism, the first hydraulic cylinder and second hydraulic cylinder being the input, the third hydraulic cylinder and the fourth hydraulic cylinder being the output.

38. The apparatus of claim 37 wherein the jack mechanism is a scissor jack.
